(19) United States
(12) Patent Application Publication
(10) Pub. No.: US 2008/0120221 A1
(43) Pub. Date: May 22, 2008

(54) Brokering Loyalty Points

(75) Inventor: Steve Toneguzzo, Rosebery (AU)

Correspondence Address: MICHAEL MOLINS;MOLINS & CO., SUITE 5, LEVEL 6, 139 MACQUARIE ST, SYDNEY NSW, 2000, omitted

(73) Assignee: GLOBAL INFO TECH SERVICES PTY LTD, Rosebery NSW (AU)

(21) Appl. No.: 11/780,481

(22) Filed: Jul. 20, 2007

Related U.S. Application Data
(62) Division of application No. 11/603,644, filed on Nov. 22, 2006.

(51) Int. Cl. G06Q 40/00

(52) U.S. Cl. 705/37

(57) ABSTRACT

Provided are business methods pertaining to a clearinghouse or brokerage that converts loyalty points to a currency (known or invented, real or virtual) in order to reduce the loyalty points liability of a corporation.

### FIELD OF THE INVENTION

One embodiment of the invention pertains to networked games and apparatus in which an actual currency or virtual currency (including points) or game based currency is used to: (a) participate or wager on an outcome of a contest of skill or chance or stamina or any combination thereof, (b) insure against an outcome, or (c) enhance the players chance of success in the contest.

Another embodiment pertains to methods for the presentation of games of chance or skill at a different time and location to that of actual result determination using a technological aid.

Another aspect of the invention pertains to methods for the conversion of customer loyalty points into a different medium of exchange and using that different medium of exchange (or loyalty points directly), to purchase participation in a lottery or other game of change or skill or both.

### BACKGROUND ART

Networked games are well known. Game-based currencies are also known to exist. Game-based currency (“GBC”) is currently known to be used to purchase items such as virtual real estate or virtual weapons or armour.

Electronic gym, racing simulations and other like sporting equipment and simulation equipment is known to exist. A person uses equipment of this kind, generally to simulate an activity, and can produce one or more output signals that are indicative of a user's performance.

Networked, simulated casino style games, lotteries, Internet poker and even Internet billiards exists currently. These games may be played for points or tokens or simulated or real cash.

Internet Sports betting exists, whereby the participant may wager on the outcome of a real event, or in the case of fantasy sports, a simulated event.

The purchase, game determination and payment of prizes will generally occur in a licensed area or another location where it is legal to gamble and in accordance with appropriate legislation which usually specifies that location and time. The actual gambling location may be unlimited where the activity occurs using a PC or wireless or other computing device with communications capability.

Technology assisted gambling comes in many forms such as poker machines, lotteries, internet, wireless or other forms of remote gaming. Many forms of chance and skill games are available.

In the United States and other jurisdictions “remote” or off-site gambling is considered to be illegal. Certain exceptions are:
a) In the generation of a scratch lottery or pull-tab the tickets are pre-printed at a location other than the location where they are purchased and “played”.
b) The purchase of a scratch lottery ticket at an agency (the game is pre-determined at the time of purchase) then scratching to reveal the prize at the venue where it was purchased, or at a later time and place. The winner must generally return to a licensed area to claim the prize. In this case no electronic aid is used to display the results.
c) In online lotteries a pool of “pull-tab” results may be pre-generated electronically and at the time the player places a wager to purchase a ticket, the result is displayed. This is not legal in all jurisdictions.
d) In Class II Indian Gaming where a “technological aid” to Bingo and Pull-Tabs is permitted, an electronic “pull tab” machine may be loaded with a CD containing previously determined game outcomes. A person who plays the machine simply sees a display of the pre-determined pull-tab outcomes (often in the form of a slot machine display) as the individual pull-tabs are also printed. They must then take the winning printed tickets to a cashier to redeem their prize.
e) Parimutuel, interstate horse wagering.

Prior art discloses a casino system that stores a session file which may be used to replay the game at a later time. The remote game server may be accessed over a communications link, such as the Internet.

A third embodiment relates to loyalty points. Shells or cattle were used in antiquity as a form of currency. Today, the second largest currency in the world is loyalty points. These points may form a significant liability on the balance sheet of a company. In 2004, the estimated global loyalty point liability exceeds $400 Billion (NIKKEI, April 2004). There are know schemes for the provision of a facility to convert one type of loyalty point into another form of loyalty point (or cash equivalent) to cross-purchase. It would be convenient for large corporations to seek alternate means to dispose of their loyalty points liability. One effective way to do so is to have them used in gambling transactions or converted to a pseudo or new form of currency that enables the free trade between participants.

As with most businesses, the primary means of growth for properties in Las Vegas involves the acquisition of new customers. This could involve finding customers who previously were not aware of product (first time to Las Vegas), were not candidates for purchasing product (just turned 21 years of age), or customers who in the past have bought from competitors. Some of these customers might have been customers previously, which could be an advantage (more data might be available about them) or a disadvantage (they might have switched as a result of poor service).

The traditional approach to customer acquisition involved a marketing manager developing a combination of mass marketing (magazine advertisements, billboards, etc.) and direct marketing (telemarketing, mail, etc.) campaigns based on their knowledge of the particular customer base that was being targeted.

Las Vegas type casino gaming customers tend to cross all marketing platforms:
(a) Promotional offer seekers
(b) Customers loyal to one property
(c) Affluent visitors with no disposable income conscience

The one attribute that crosses all these sectors is that Las Vegas visitors like to feel special and like to feel that the operator is taking care of them.

Successful loyalty marketing programs create loyalty to the brand. Performance is judged with a combination of behavioural and attitudinal measures, and the objective is to focus and deepen the existing customer relationship, by offering relevant rewards that reinforce the brand values.

Loyalty marketing is a strategy, not a tactic. Customer loyalty, and customer loyalty acquisition, is based on relationships. In loyalty marketing, the program designed to motivate and encourage desirable behaviours by using the right rewards and personalization, ensures loyalty almost every time, and for the long term.

Currently, Las Vegas operators use loyalty point rewards programs, mainly through the tracking of a customer's play via player cards or observation of staff.

An aspect of this invention provides the necessary tools to help gaming operators maximize their acquisition and loyalty programs, all at once.

### SUMMARY OF THE INVENTION

In a first embodiment a networked adventure or simulation game or contest or similar, players, participants or third-party observers may use an actual or virtual or game based currency (“GBC”) for gaming and wagering transactions, including the purchase of insurance or to increase their chances of success within the game.

The game or contest may be witnessed, for example in a network environment, by any party via visual signals such as a screen or virtual reality display or hologram or via a voice or other auditory or sensory signal. For example, users, spectators or gamblers may appear as avatars or themselves in a simulated stadium or grandstand, whilst performers may appear as avatars or themselves on a simulated racetrack, golf course, basketball stadium or other such sporting facility.

In a second embodiment, gambling games of chance or skill (however and whenever determined) when re-played or displayed to simulate a result at a location and time other than the exact location and time where and when the game transaction was made, may be represented as a multi-state game, or the player may have the option to select the design or pattern or look and feel of the game (provided the fundamental rules of play or game engine, remain unaltered by the player's choice). The player may purchase games in “bulk” and in doing so may specify or select the key parameters of the game (e.g. number of reels, pay method, pay table).

A third embodiment has three separate aspects:
(a) “Auction House”—businesses compete for a patron's business.
(b) “Clearing House”—businesses can dispose of point liability via a point exchange for a common value (e.g. a form of currency). This invention should not be confused with converting points between merchants or having merchants accept each others points directly or through a broker.
(c) “Lottery”—businesses can dispose of point liability via a lottery or similar.

Clearing House and Auction House could be melded into one business model, method and architecture, based on a promotional currency.

Clearing House and Lottery could be melded into one business model, method and architecture, based on the use of a common currency into which points are converted, being used for the purchase of a game of chance or skill or both.

### BRIEF DESCRIPTION OF THE DRAWING FIGURES

FIG. 1 is a flow chart illustrating a game transaction interface;

FIG. 2 is a flow chart illustrating a process flow for the remote witnessing of a game;

FIG. 3 is a flow chart illustrating methods for auctioning customer expenditures;

FIG. 4 is a schematic diagram of business architecture;

FIG. 5 is a flow chart illustrating the steps associated with a loyalty point exchange for currency; and

FIG. 6 is a flow chart illustrating the steps in a gaming method involving promotional currency.

### BEST MODES AND OTHER EMBODIMENTS OF THE INVENTIONS

In one embodiment, a simulated “International Sporting and Athletic Games” could be facilitated using real competitors competing with each other in real-or near real-time events, being watched and wagered on by millions around the world, without anyone needing to leave their hometown.

Monitoring of the event may be done by email, telephone, SMS, kiosk, narrowcast, broadcast etc. Users include performers, wagerers, and spectators. Users of the system may wager on an outcome determined by the performers. In some embodiments only selected users can make bets. Performers may be excluded, as may certain users based on age, location or conflict of interest

Performance equipment and other components may be subject to scrutiny and testing to provide for integrity in the game or contest.

Performers, players or spectators (players) may pay a fee to enter such that the sponsor, house (provider of the equipment) or server operator obtains a percentage and the winner of the event obtains a prize pool.

In the alternate, the event may be web-cast or broadcast and a sports-book managed by an entity to enable parties independent of the participants to wager on the outcome.

In one example the player or players uses a game based currency to wager in a virtual casino or sports book associated with the game. The wager may be made directly with a gambling service provided by the game, or with a transfer of funds to a third-party provider associated with the game. A virtual sports book may take bets on actual sub-games (for example, fights or battles, or tournaments or contests) within a game.

A player (or team of players) uses a game based currency to enter a virtual tournament whereby the house, sponsor or server operator takes a percentage of the entry fee and the winner takes the balance (e.g. a virtual jousting or fighting competition).

In one embodiment it is envisaged that there would be a virtual colosseum, where gladiators fight against each other (individually or in teams) in cyber-space to be recognized as the best. The game would simulate many or all aspects of the traditional gladiator battles and the associated commerce, or adopt variations or new concepts. The Spectators may bet on the gladiators in the virtual sportsbook and vote for the thumbs up or down.

A player or players use the game based currency to insure themselves through a virtual “broker” against loss in a game (loss of property, virtual life or virtual health etc.).

The Invention also contemplates the provision of insurance within a game.

A player or players use the GBC to enhance their chances of success in the game (extra strength, weapons, engine parts, etc.). A player or players use the game based currency to purchase virtual components that have specific characteristics that when combined result in the creation of a virtual vehicle or combat weapon or other device to be used in the game, a sub-game or tournament. The game based currency is to be used for the payment to assemble the components and the reliability of that assembly may be based on a random outcome or component of skill (e.g. based on the experience of the assembler). That reliability factor can then be a consideration in the determination of a “breakdown” or “malfunction” in a game, sub-game or tournament.

Important components of this invention include:
a) A contest: of chance, skill, stamina or one of more of these attributes.
b) A game based currency: As used within a game, representations or symbols of real money, simulated money, an invented currency, or loyalty or other points that are ultimately convertible by the player into real money, or an item or thing of value.
c) Players in the game: Contestants or spectators.
d) Virtual representations of the participant on a display visible to either participants or spectators.
e) A simulation device or apparatus: To enable participants to engage in the game or contest.
f) A networked output device: To enable participants to see, hear, feel, sense, smell or taste the event and the outcome.
g) A game transaction engine interface: To enable the participants or spectators to insure themselves or others, wager on an outcome involving themselves or others, enhance their chance of success or enter a simulated casino or betting shop—a game within a game.

It is envisaged that (g) may be added to existing simulated sporting games such as golf or multi-user adventure games. It will be understood that the operator of the game may profit either by collecting fees or taking a fee or a percentage of the transactions generated by converting real to GBC, or GBC to real money. Fees may be collected based on player participation or through commissions on the sale of insurance, premium weapons, game tools, virtual services or products.

In the example of simulated golf, extra money could be paid to obtain better clubs (enhancement).

In the example of an adventure game the player could;
(a) Insure themselves against getting “killed” by a monster or other player,
(b) Place a wager on the outcome of a fight they (or their team) are about to participate in with another player(s).
(c) Place a wager on a fight about to occur in the game, that the player will observe.
(d) Enter into a tournament whereby an entry fee is paid and the winner (or winners) and the house divide the pool of entry fees.
(e) Engage in transactions with a virtual gambling house within a game.

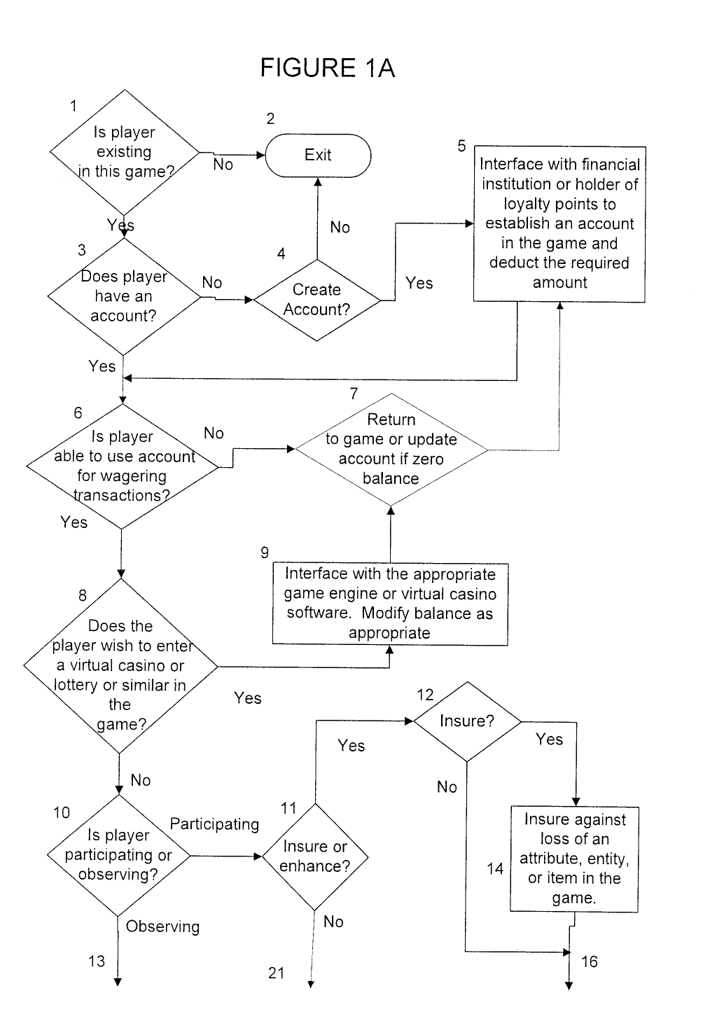

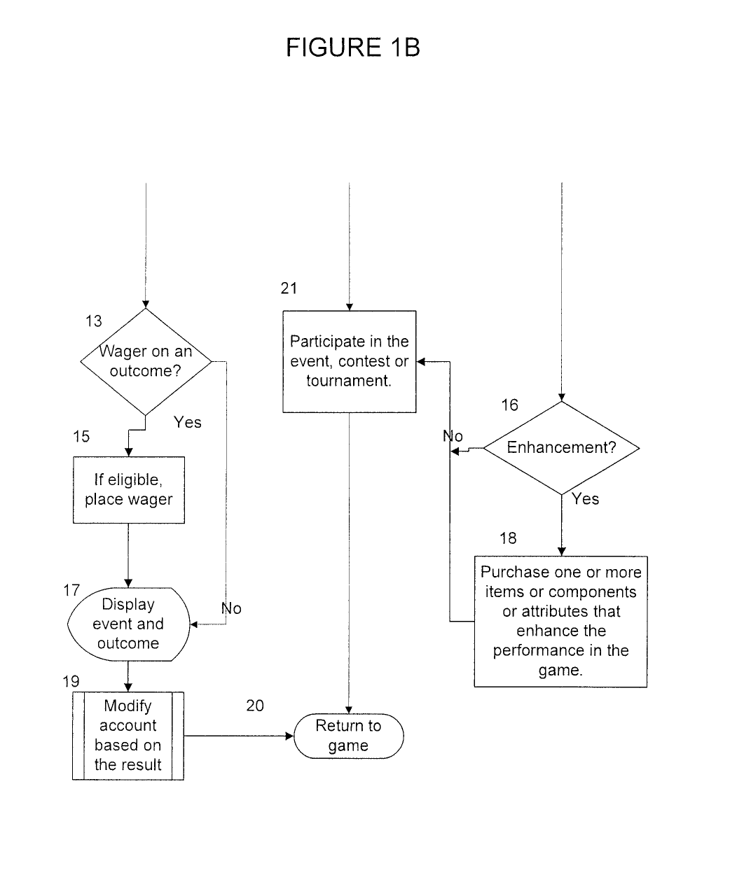

The game transaction engine interface, process flow is represented in FIG. 1.

In FIG. 1, a player may be registered on a system, but the interface first establishes if the player is existing in the game (1) and if not, exit (2). Having established that a player is game resident (1), the interface determines if the player has an account (3) and if not, the player is given the choice (4) to either create an account (5) or exit (2). When a player account is created (5) there is an interface with a “financial” institution or other entity where the player holds an account (using actual or pseudo currency, game based currency or loyalty points accumulated with any participating merchant), and the appropriate fees or nominated amount are deducted and the player account credited. During or before the account creation process it is expected the identity of the player will be verified.

Once an account is established, the system then determines if the player may gamble using their account (6). The general criteria would be: (a) Is the player's account balance positive? (b) Is the person over legal age? (c) Are there any exclusions on the person (e.g. known cheat or self-excluded problem gambler). If the player is unable to participate they return to the game (7), or in the case of a zero balance they player is provided the option to top-up the account.

If the player is able and willing to gamble then, at some time in the game the player will be presented with a choice to decide which sort of game they wish to play(8). In the case of a game of chance (such as a lotto or casino game), the player is presented with the option to play (9). The playing options might be through a virtual gaming house (e.g. Casino) in the game a known brand might have a virtual shop-front in the game, but when the player's avatar walks into that shop, the game transaction engine interface effectively and seamlessly transports the player to a third-party game provider, where the player's balance credentials and other applicable data is transferred and the account is modified accordingly as a result of player activity in the game.

If the player wishes to engage in a sports, tournament, contest or related activity then the player must decide (10) is they are to participate or to observe. If the player is to observe then an entry fee (e.g. to a virtual sport stadium or race-track or arena) may be charged (10) or not and the player is provided the option to wager on the outcome of the event (13). If the player decides to wager, they the player is assessed for eligibility (e.g. one example criteria might be a conflict of interest) (15) and if permitted, may select the event or events and place one of more wagers (15). The player may observe the event or events and outcome or retrieve the outcome at a later time (17), the account is modified and when the player decides, the player returns to the game (20).

If the player decided (10) to participate rather than observe then the player will decide if they wish to insure their avatar against a thing happening (e.g. loss of an arm in the game) or enhance their chance of winning (11) and if not, the player will participate in the event which may or may not involve an participation fee (21). Having decided not to participate before taking precautions or being prepared, the player decides (12) to take out insurance or not. If they do decide to insure against loss or damage to an attribute, entity or item in the game the player will select the option and accept the terms of the policy and have their account deducted accordingly (14). Insurance might be supplied by the game provider or by a third party provider.

The next decision (16) for the player is to enhance or not (participate in the event, 21). The enhancement process (18) may involve purchasing training (e.g. gladiator training), or it may involve purchasing one or more items (e.g. a race car or a sword) or components (e.g. spare tires or bullets) or attributes (e.g. health) that enhance the chances of winning an event. The process may also involve acquiring services, such as the assembly of component parts purchased to construct a racing car.

When the player has completed the insurance and/or enhancement options they may then participate in the event (21).

In a second embodiment, player purchases one or more games at a particular location. The location may be a casino. Where the gambling activity occurs using a PC or wireless communications device, the actual gambling location may be anywhere. These games may be games of chance or skill. The rules for the game may be selected by the player (e.g. the player selects to play a certain type of game and purchases one or more). The result for these games may be determined, e.g. in bulk, at the time of purchase (e.g. slot type game) or may be pre-determined (e.g. scratch type lottery ticket). The game results may or may not be witnessed at the time of purchase. It is important to note that gambling law prescribes a game as placing a bet, the outcome being determined, and a prize of value being determined or awarded. The observance of the game by the player is not a legal requirement of game play. Hence, this embodiment provides for the player purchasing (and playing) many games in an instant, but observing the actual results at a later time. This is a critical variation on prior art where the game is actually observed during play, data stored and may be replayed.

In this embodiment, the game result is stored on a device (other than a printed ticket) and is able to be recovered and displayed either using the storage device or another means to access the storage device.

Using a technological aid, the game play may be witnessed by the player remotely from the exact or actual location of gambling at a different time from where and when it was purchased or first carried out. In this embodiment, the player may witness the replay of multi-state games (where the perception of choice is provided, but the prize outcome is ultimately unaltered from the original game), and the player may choose how they wish for the game to presented to them by selecting different game themes (provided the prize outcome is ultimately unaltered from the original game).

The purpose of the re-play is primarily for the player to witness the gaming outcome for the first time.

By way of example:
a) A player enters a licensed area (e.g. a casino). The player then selects parameters (e.g. 5 reel slot, pay rules, or simply game type) purchases 100 games (e.g. bulk purchase or play) of a favourite game at a terminal and the results of those games are determined (e.g. played) and stored. The player is either provided with a transaction identifier or is identified (e.g. using a player loyalty card) and the game results are linked to either the player ID or the unique transaction ID. The player chooses not to observe the game outcomes or to collect their winnings at that time. The player then goes home, logs onto the venue's web site account using some form of identification and requests to re-play the games played that day over the internet, pay TV, mobile phone or other communication media. The player selects the game theme from a list of options (and may vary the theme from game to game, such as watching the play of $50 of theme #1 and then $50 of theme #2, where the themes adopt the same game engine). The player thus watches the games play (for the first time) from a remote location and at a remote time and observes their winnings and losses at that time. The player then enters a licensed area and provides their transaction ID or player loyalty ID to redeem any winnings that are owed. The player may also choose to redeem the winnings at the time of purchase.
b) A player may elect to hear the results rather than see them (e.g. a simulated race called over the telephone or internet).
c) Rather than an electronic identifier (e.g. transaction ID or player ID), the player may elect to have the results loaded on a mobile device (such as a smart card, mobile phone, PDA, or other device.
d) Rather than an electronic identifier (e.g. transaction ID or player ID), the player may elect to purchase a device with the results pre-loaded. The player may elect to re-use that device time and time again.
e) The technology involved may be an adaptation of existing Internet gaming systems, systems based gaming, or lottery systems or similar.
f) Actual currency, a representation of actual currency, points or “promotional play” may be used to place a wager and pay a prize.
g) It is commonly known to game developers that games are generally comprised of (a) sound, (b) graphics, (c) game engine (i.e. how the game is played), and (d) pay table (i.e. how the game prizes are awarded). Provided (c) and (d) are constant, various graphics and sounds can be substituted to “re-skin” the game. So essentially, a player could be presented with many different graphic or sensory representations of the same game. Hence, this invention provides for the option of a player to select from a variety of game “skins” to remotely witness the outcome of prior game play.
h) Single-state games (e.g. a spinning reel slot machine simulation), involve no player participation: You either win something or you do not. Multi-state games (e.g. draw poker) generally involve an aspect of player choice. The invention provides for the player to “replay” a multi-state game but be awarded the prize for the best hand they could obtain. This is illustrated by way of the following example:
a) The player has previously purchased a $1 hand to replay.
b) The computer selects 10 random numbers and maps them to a deck. Let's say: A-C A-H K-C 2-D 5-D 3-S Q-D A-D 4-D 8-H (where C=clubs, D=diamond, H=hearts, S=spades)
c) The first five cards are dealt: A-C A-H K-C 2-D 5-D
d) The player discards the last two cards and is provided with replacements: 3-S Q-D
e) The player now has a final hand of: A-C A-H K-C 3-S Q-D
f) The player is paid for an inferior hand, being a Pair of Aces: Say $25. The player is also paid a $25 Bonus in some manner because the best the player could have done was to discard the last three cards: K-C 2-D 5-D
g) Hence a superior hand in this situation would have been: A-C A-H 3-S Q-D A-D, or Three Aces.
h) Let's say Three Aces pays $50. Hence, the difference is $25. As this is a pre-played game the net return to the player in the replay cannot deviate from the original game play. Hence the optimum outcome must be applied in all cases. Had the player originally discarded the three last cards and realized three aces, no bonus would have been paid.
i) An alternate to actually playing the hand once, is to keep replaying it until the optimum strategy (e.g. the choices that pay the highest prize) are obtained.

To further illustrate how player choice has no impact on the prize outcome, the following example is provided:

The first hand is A A A A 7, say.

One could make an irrational choice and discard A A A 7, leaving the player with only an A. If it so happens that the next four cards in sequence are K, Q, J, 10 of the same suite as the A, then the player will have obtained a high award from an irrational choice.

However, in “remote witness of game play” because the game is pre-purchased (and top prize pre-determined), the player's choices do little more than provide an interaction, regardless of what they do, they will win the same amount. Hence;

The irrational play would see the player win the prize for a straight flush.

The rational play would see the player win the prize for four aces+a bonus=the same prize as the straight flush.

The deck is essentially reshuffled at every hand, so one has no way of knowing the state of the deck. At the start of each play there are 10 cards pre-selected, those cards and the sequence of those cards cannot change.
j) An alternate method to provide multi-state games is demonstrated as follows:

A perfectly random 5 cards are dealt. The server will then use “optimum strategy” to determine what cards to hold. Then, the server will deal the requested cards to the “discarded” slots. The resulting hand is analysed, and a payback for that hand is assigned.

Now, when the player goes to make his choice of outcome, the same random cards are analyzed in place of the player's discards. Then the following analysis takes place:
a) If these cards do not yield a result equal to or less than the pre-determined payback, then another set of random cards is drawn. This is continued until the result is equal to or less than the pre-determined payback.
b) If the cards yield a result equal exactly to the predetermined payback, then the player is shown those cards, and the payback is awarded. The player is given no “bonus money”.
c) If the cards yield a result less than the predetermined payback, then the cards are shown to the player, and a “win” equivalent to that player's resultant hand is displayed. Further, a “bonus” is awarded in the amount of the pre-determined payback minus the displayed payback.

A multi-state game, in this embodiment includes poker, blackjack, bonus features, second or multiple state games, known or yet to be invented. The implementation would adopt the same basic principles as those described previously, where the ultimate prize remains the same regardless of the path chosen by the player.

Important components of this embodiment are that there must be:
(a) A networked based gaming system complete with game engines, transaction processors and an account keeping capability.
(b) A remote interface to the gaming system such as a web site, remote or wireless terminals.
(c) A “remote witness of game play interface” or API.

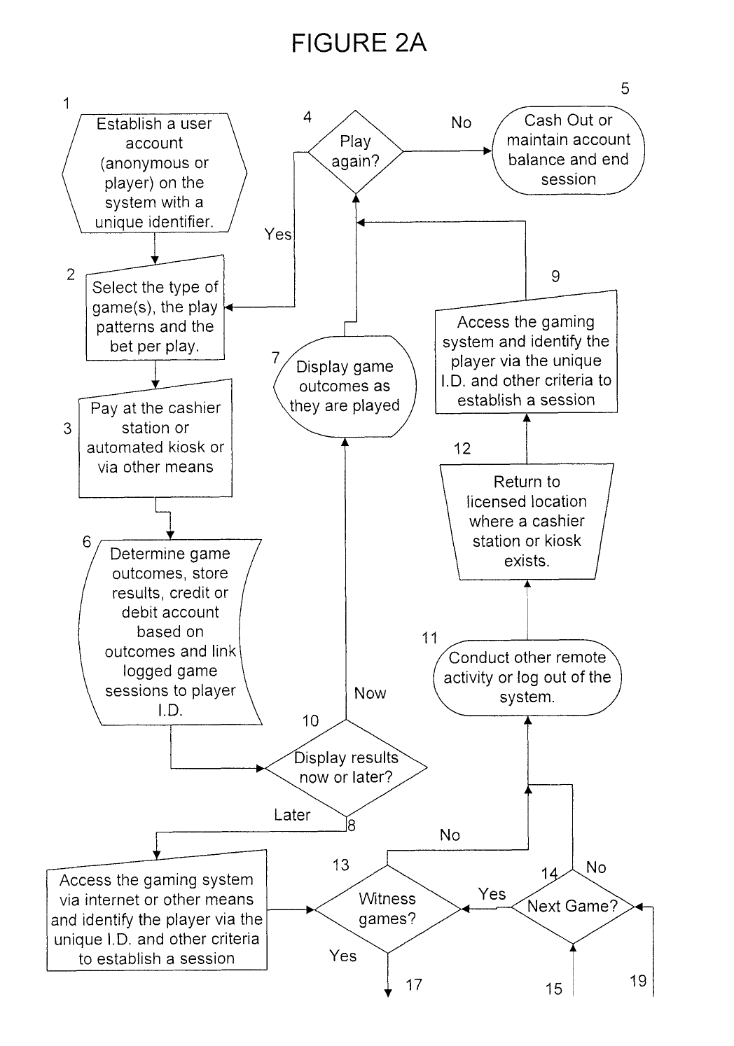

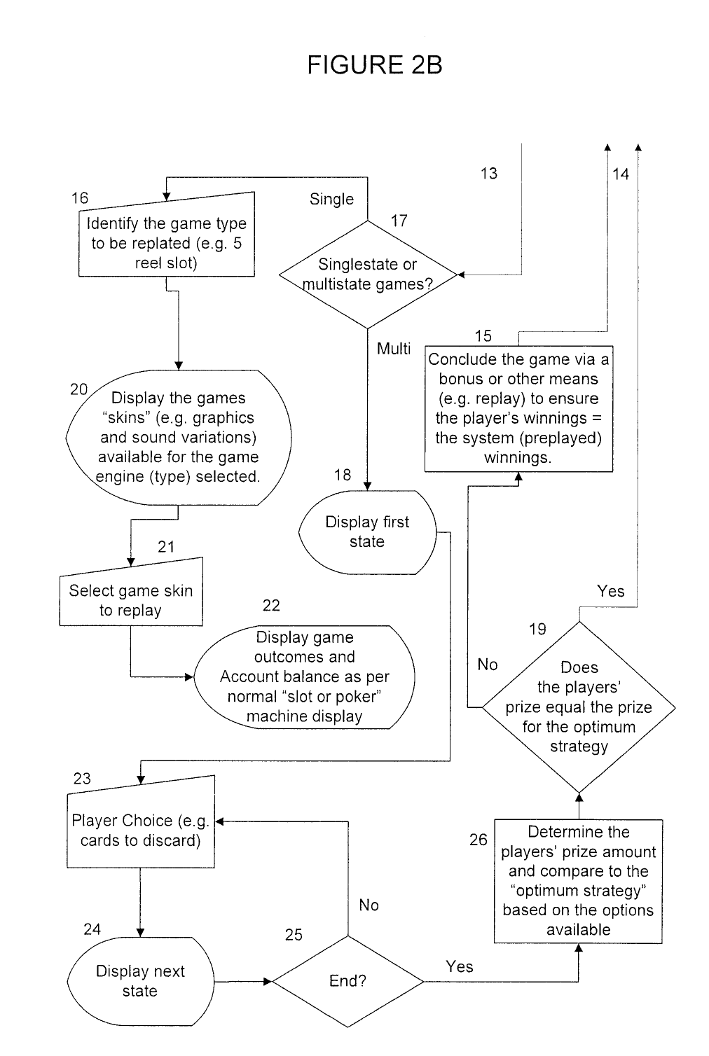

The process flow for the above embodiment is illustrated in FIG. 2.

In FIG. 2, a player must first of all establish a user account (1) and the interface confirms this (for example when a player swipes their player-card at a kiosk). The player is then given the option of selecting (2) a game type (e.g. 3 reel or 5 reel) and the rules or patterns of play (e.g. pays left to right, scatters pay any, etc.). The rules may be defaulted by the game type the player selected. The player then selects the number of games selected to bulk purchase and payment is made at the cashier station or kiosk or via other means such as using a cell phone (3). Once payment is made, the interface instructs the gaming system to determine the outcomes, store the results, adjust the players final account based on the outcome of all games selected and link the logged game sessions to player I.D. (6).

So at this point the player has effectively purchased a selected number of games in bulk, which have been determined by the system, but the slaver has not vet seen the outcome of the games. In a way it is like pressing the button a number of times on a slot machine where you see nothing, but your final account balance and as such 10 games or 1000 can be realized in an instant. Following the transaction, the player is then given the option to display the results of each game or to do so later (10).

If the player decides to display the results now, they player may be instructed to move to another terminal (e.g. the bulk purchase of games may have occurred at a cashier window or the operator supplies play terminals that have no cash transacting capability) where the may witness the graphical and audio representation of the play of each game for the first time (7), in a manner analogous to the player actually playing the game. However, the player is not betting, playing, and potentially winning, the bet and play and win has already been determined, so the player is not gambling, by law. As such the remote witness of the game play could occur on premises that are not licensed for gambling. However, winnings must be collected from licensed premises (5), should the player decide not to play again (4).

If the player decides (10) to display the results later, then at a later time and probably in a different location, the gaming system must be accessed (perhaps via the internet) and the player authenticated (8). The player is then given the option to witness game outcomes (13), and if they decide to, the player is next given the option to witness single or multi-state games (17).

In the event of a single-state game, the player must identify the type (16). It is common practice in the gaming industry for a game manufacturer to develop a common game engine, but to have many different “skins” or “themes” whereby the graphics and sound is different, but the game plays exactly the same (20). Using this technology, the player can then decide which theme or themes (21) to use to observe their prior game purchase. If for example 100 games were pre-purchased, the player may choose 10 different themes to witness the play of 10 games for each theme. Having made the decisions, the player then observes the play (22) at the selection of each “spin” (or similar) button with the credit meter incrementing or decrementing and all other displays operating as they would as if the player were sitting in front of a traditional slot machine. Once complete, the player is given the option (14) to select another game or not. The player may repeat steps (17), (16), (20), (21), (22) one game at a time or in bulk as in the above example.

If at (17) the player elects to play a multi-state game, then the player may still select a game theme and elect to witness one or more games. At (18) the first state is displayed (e.g. In the game of poker that first state would be 5 cards). The player then interacts and selects which cards to keep and which to discard (23). The next state is displayed (24), which in the case of poker would be the replacement cards. If the game is not over (25), then the next state is presented until the game ends at which time the game considers the player's choices and compares the prize result from the player's choice against the prize result from the optimum play (26). If the player's result matched the game result (19) the player is provided the option (14) to play the next game or not. If the player's result does not match the game result, then the prize must be adjusted (15) to compensate because the player is observing a game already determined. The prize adjustment might be through a bonus or the player might be permitted to keep re-playing the game until they realize the optimum strategy or exit, or other means.

Back at (13) or (14) in the event the player decides not to continue, the player may conduct other (perhaps account management or other activity (11) or exit the system. At a later time the player must return to the licensed premises (12) where there is a person or device that will authenticate the player (9) to enable the player to cash out their winnings (5) if they chose not to play again (4).

The need for the player to return to collect winnings is considered to be a useful marketing too.

A third embodiment brings gaming operators and customers together, with each party achieving exactly what they want. The customer wants value for his business—this could be in the form of discounted rooms, free entertainment, complimentary dining or promotional play at the casino, i.e. “comps”. These are standard offerings in Las Vegas. However, sometimes the customer may only realize these benefits after his stay, if at all. There are times when customers have reached a property's comp level, never to receive any complimentary offers prior to the end of their visit.

This embodiment allows customers to receive their comps before they visit and provides the customer with the ability to put their business “out to bid”.
1. The customer provides the operators with their preferences about a planned visit, for example, planned visitation date, the amount of spending money they are bringing with them, and their favorite activities.
2. The information is displayed to the participating operators who will then decide what types of complimentary items or discounts they will make available to that customer for that spending level.

The customer selects the offer that provides him the best value, or suits him the best.

Important components of this invention are:
(a) An existing promotional, loyalty marketing system in place with the Operator,
(b) An interface with the operator to exchange information and facilitate transactions,
(c) A computerized system to facilitate; (a) the acquiring of client expenditure limit and requirements, (b) the auctioning of the client's planned expenditure, and the transaction processing, and
(d) A provider of the cash for promotion exchange service that operates and manages the computerized system.

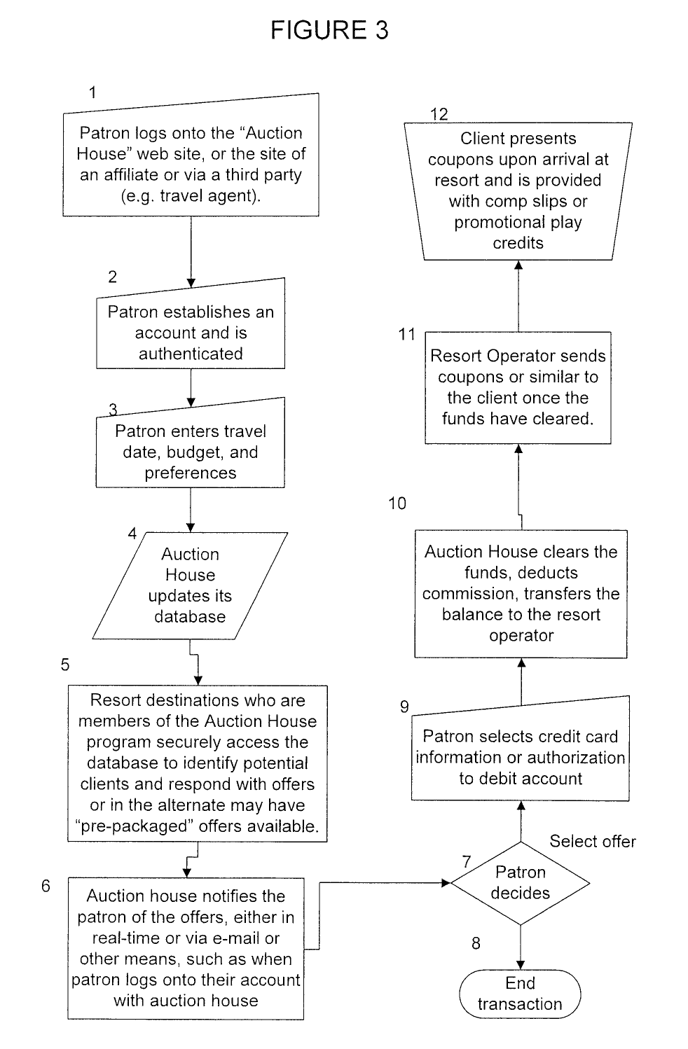

The process flow for the third embodiment is represented in FIG. 3:

A customer accesses a web site (1) that provides the service and establishes an account and is authenticated (2) in much the same way any e-commerce site provides for. It is expected that the web site will either be a travel site, or the service will be affiliated with a travel related site. The customer enters their planned travel dates, budget, and preferences into the service database (4). The customer personal details in anonymous to third parties. The service (having previously signed up hotel, resort, casino partners—the bidders), presents the preferences, spend and dates to the bidders or in another embodiment the bidders can access open “auctions” and place a bid (5). The service notifies the customer of the offers (6), and the customer then decides (7) to proceed or abandon the transaction (8). If the customer likes an offer they will transfer funds via any available means (9). The service clears the funds, deducts a commission, and transfers the balance to the resort operator (10). Once the resort operator has the funds they issue coupons or similar or advice to the customer for the services purchased and promotional offers or discounts (11). The customer presents the advice or coupons or similar to the bidder upon arrival for redemption.

### EXAMPLE

John Smith logs on to the operator's website (referred to as “Auction House” herein and in the drawings) and enters his information e.g.:
He will be visiting Las Vegas with his wife for three nights June 2 to June 5,
They will be spending $2,000 in spending money
They like to play craps, go to shows and eat at fine restaurants
Auction House charges his account $2,000 (from which it deducts a fee before handing the difference over to the operator).

The Auction House displays this information to the operators, and they bid for John's business:
Green Casino will offer John and his wife 25% off normal room rates, 2 free meals and give him two free tickets to see a show for Saturday June 4^{th}.
Casino Palace offers John and his wife two tickets to see a show Friday June 3^{rd} and gives them $3,000 in promotional casino play.
Vegas Bay offers John and his wife $2,000 in promotional casino play.
Game Island is almost sold out that weekend, so they only offer a 10% reduced room rate.

John and his wife choose to stay at Casino Palace and they are directed to bring their confirmation package to the VIP Desk upon arrival.

The benefits to each party are:
John and his wife
   Feel special that the properties were vying for their business
   Receive $3,250 in value (their $2,000, $1,000 promotional play, and $250 in value for the tickets)
Casino Palace
   Gain The Smith's business (customer acquisition)
   Add them to their database for marketing (loyalty marketing base)
   Fill their casino with loyal customers
   The promotional play is tax exempt (in Nevada), therefore instead of being taxed 6.5% on $2,000, they are taxed nothing on $3,000.
Auction House
   Receives a fee (say, 5%) as the broker for the transaction ($100)

It's a “win-win” for everybody. The properties have the ability to offer more discounts and comps at slower times, and continually update offerings based on market demand.

Customers receive complimentary offers up front, creating loyalty and value, and the two may continue a relationship in the future. It's a simple customer acquisition and loyalty marketing tool all in one. Large travel agencies could be used as affiliate marketers/front-end partners to increase the potential market.

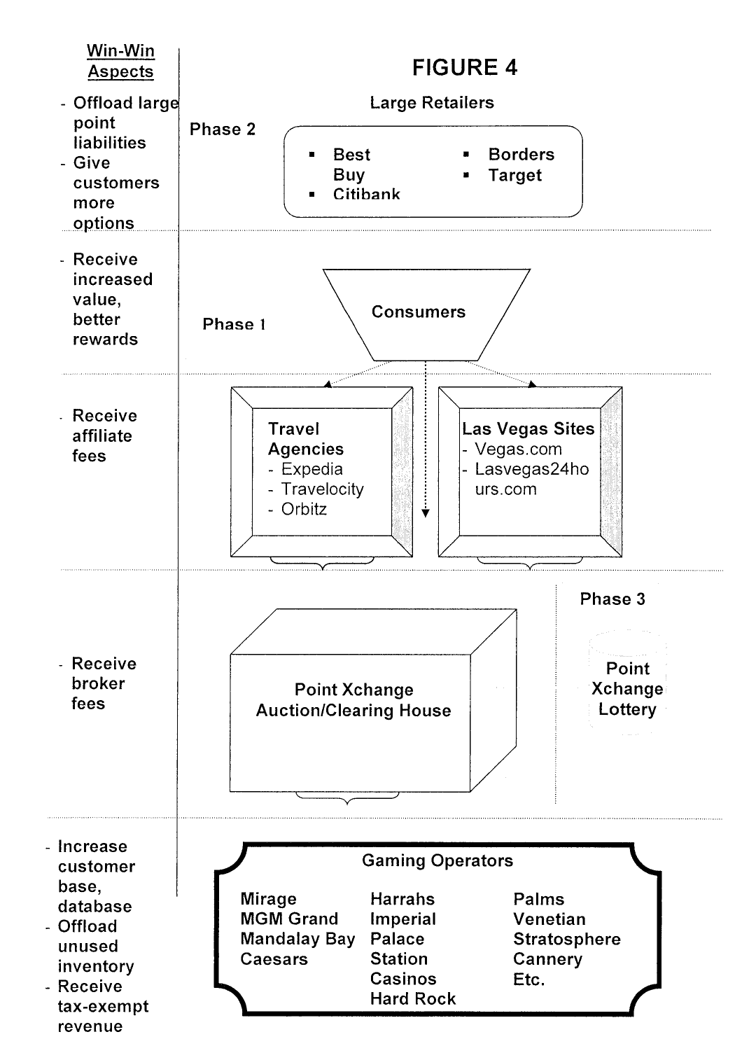

A schematic diagram of a business architecture relating to an auction for a customer's business as shown in FIG. 4.

### EXAMPLE

### Financial Model

Summary financial model follows:

Auction House Estimated Year 1 Revenue

| | |
|---|---|
| 2004 Las Vegas Visitor Volume | 37,400,000 |
| 2004 Online Booking Percentage | 23% |
| Estimated Visitors Booked Online | 8,533,000 |
| Clearing House Est. Market Share | 1% |
| Clearing House Est. Customer Base | 85,330 |
| 2004 Avg. Expenditure per Las Vegas Visitor | $901.34 |
| Est. Clearing House Market | $77,570,000 |
| Clearing House Fee Percentage | 5% |
| Clearing House Est. Revenue Year 1 | $3,878,000 |

Gaming Operators Estimated Year 1 Revenue

| | |
|---|---|
| Clearing House Customer Base | 85,330 |
| 2004 Avg. Gaming Expenditure per Las Vegas Visitor | $545.00 |
| Incremental Revenue to Operators | $46,500,000 |
| Plus: Tax Saving due to Promotional Play (6.5%) | $3,022,000 |
| Less: Clearing House Fee | $3,878,000 |
| Total Net Incremental Gaming Revenue | $45,644,000 |

Gaming Operators Build Loyalty Marketing Database

| | |
|---|---|
| Assume that 50% of patrons are not in the database: | 42,665 |

Loyalty marketing rewards campaigns in every industry—travel, retail, books, banking—give their customers reward points for doing business with companies. However, many times the rewards offered (watches, flights, etc.) are not suitable for the customer or are not considered valued products.

A further embodiment referred to as “Clearing House” (A brokerage or agency to facilitate the transactions disclosed herein) takes on point liabilities from different organizations and converts them to a universal or pseudo “currency” that may be adopted by various organizations to trade in goods and services, or for gaming.

The pseudo or new form of currency may be regional, state or province, country based or even global—such as an existing or to be invented web-based currency.

The pseudo or new form of currency may be used for gambling transactions.

The benefits to each party are:
Customer
   Greater flexibility with the use of points.
Company with loyalty point program
   Eliminates the point liability from its books
Clearing House
   Receive a fee (%) as the broker for the transaction

The major components of this invention are that there must be:
(a) An existing promotional, loyalty marketing system in place with the participating suppliers of goods and services,
(b) A computerized system to facilitate the transfer and funds management of point equivalent currency, and
(c) A provider of the point exchange service that operates and manages the computerized system, exchange and banking facility.
(d) Companies prepared to accept or trade in the form of currency offered by the broker (“Clearing House”).

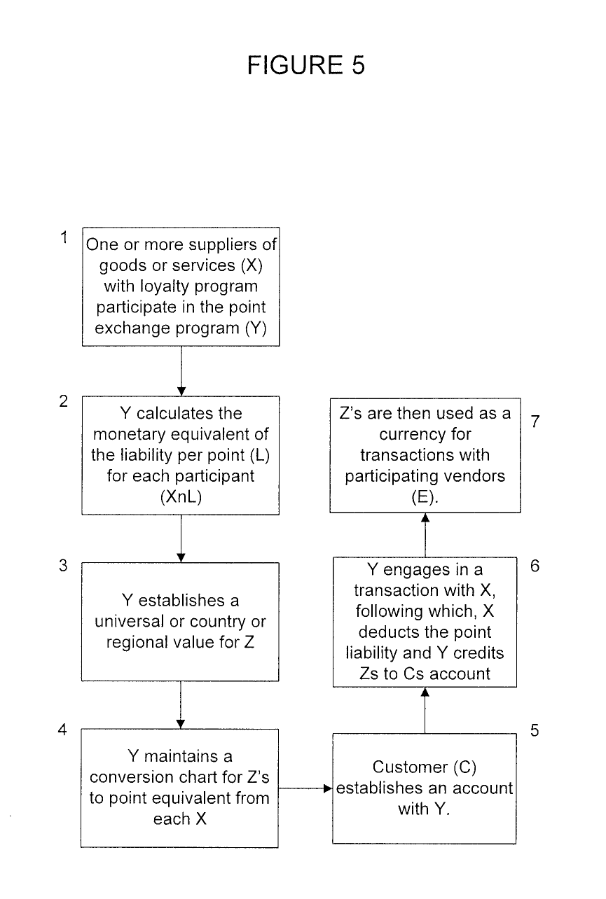

The process flow for the clearing methods is represented in FIG. 5.

This is not an exchange of goods and service for points between participating companies as that has been done before. This is purely an exchange (or equivalent) to convert points to currency or pseudo currency.

The clearing house “Y”, forms business relationships with suppliers of goods and services with loyalty programs “X” (1) and vendors willing to provide goods and services for pseudo-currency. Y maintains figures on financial equivalent for each X (2), and established one or more pseudo-currencies with associated value “Z” (3). For example, 1000 points may be worth 1 c each or $10.00. Y maintains a currency conversion from points to Z's (4) and makes this available to participating customers who hold accounts with Y (5). In our example, X might pay Y $5.00 to wipe the $10.00 off the books. Y will need to make a commission, so Y might deduct a 50% or $2.50 fee, leaving $2.50 available to the customer. So Y might make the 1000 points that the customer held with X, worth 2,500 Zs, where the perception of value is maintained. The customer then transacts with X to instruct in the conversion of points to Zs and Y facilitates the transaction and credits the customer's account with Z's (6). In our example, the customer balance would hold an additional Z2,500. Z's may then be used by the customer to engage in transactions with participating vendors “E” (7). Such vendors could be virtual games (where Z's are used as or converted to a game based currency), or E might provide real products and services or E might supply an entry to a gambling game (e.g. lottery) or E might convert the Z's to stock. It is also possible that Y, X, and E or any combination thereof are the same company or entity.

In the event where the Z's are used to purchase lottery or game tickets, the financial model could differ where Z's are converted directly from the cash equivalent of points and the broker makes its money as a commission on the total tickets sold (as opposed to points converted) for operating the game.

This next embodiment pertains to the creation of a lottery using the created promotional currency or by way of contribution of different point programs toward the acquisition of an entry “ticket”.

Tickets or gaming vouchers may be purchased from pseudo-currency or converted directly from points to tickets or gaming vouchers.

As customers convert their points through “Clearing House”, they can use their points to buy into lottery drawings and sweepstakes or similar or in the alternate, the Clearing House will act as the “broker” of points and operator of the lottery.

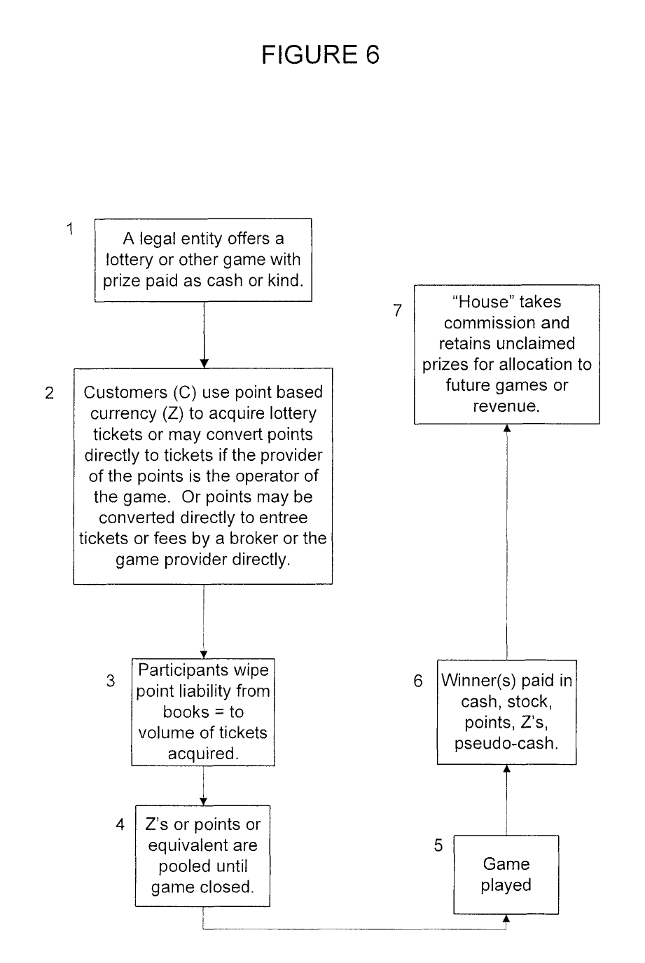

With reference to FIG. 6, for example, “X” is a company that provides a product or service and a loyalty point program.

“X” has determined that one loyalty point has a specific liability, “L”.

A customer, “C”, of X has accrued “M” loyalty points with X.

X has an affiliation with a Points Clearing House (or brokerage or auction provider), “Y”.

Y also has relationships with one or more entertainment, retail facilities, or any other merchant or provider of goods or services, “E”, who desire to secure C's points in the form of an actual or invented means of exchange or currency “Z” (possibly referred to promotional credits or “dollars”) and thereby attract C to utilize facilities or services of E.

In the alternate, X may also perform the role of Y or E may perform the role of Y.

In the example of a shop, the offer may be that if C purchases a thing, C can purchase any other thing to the value of the total of accumulated Zs.

In the case of the casino industry, Zs may be “Promotional Dollars” which are a generally accepted term whereby a player must play the promotional dollars, the player cannot cash them, but they are permitted to convert any winnings to cash or kind. Promotional dollars are an attractive way to secure the patronage of C when they visit, often resulting in purchases at other facilities in the casino, accommodation, or additional gaming spend.

In one embodiment C calls an employee of Y to engage in dialogue, or accesses Y's computer servers over the Internet, pay TV, mobile phone or other communication media. C identifies how many Z's Y's E affiliates are offering in exchange for C's points held with X. Or in another embodiment, how many Zs will E allow C to convert their N points held with X to?

C is planning a trip to Las Vegas and notes that E1 casino is offering an attractive deal that, for example, if more than 50,000 Zs are converted, E1 will provide a free room. C likes that deal, and instructs Y how many points they wish to convert to Zs with E1 and proceeds with a transaction.

“Y” negotiates to take a number, “N” (where N<=M>0) of C's points off X at a value “V” per point where V would generally be less than or equal to L.

In one example, X transfers the points to Y at no cost, V=0 in order to reduce X's liability.

Or X may pay Y, V/point to take the N point liability. Hence X's liability is reduced by N x(L−V).

Or Y may pay X, V/point to take the N point liability. Hence X's liability is reduced by N x(L+V).

Y now holds N points for, or in trust for C.

In one example, Y sells C's points to the chosen E at a pre-agreed rate.

Or Y advertises C's points for sale to its E affiliates at a given rate, and whomever sees the deal being most attractive buys,

Or Y notifies its E affiliates that C has N Zs and the E affiliates auction or bid for those Zs with X. The result that X sells C's points to the highest bidder.

In any event Y converts points to Z's (which may be points or a currency known or invented), and E purchases Z's off Y to establish a Z banking or trading account for C.

Or in the alternate, Y converts points to Z's (which may be points or a currency known or invented), and Y pays E an amount for E to take over the Z liability.

The method of the invention also provides that C can convert or exchange some or all of their loyalty points with X to a common, actual or invented means of exchange (including web-based currency) or currency pseudo currency, “Z”. Y converts the customer's points to Z. In preferred embodiments Z is then used with Y, to allow the customer or his agent or assignee or nominee to engage in a transaction.

Y sets the rates of conversion to Z either alone or in affiliation with its partners X and or E. Z may be a known currency (such as US dollars) or a virtual or invented currency.

By way of a simple example:

C holds 100,000 points with X and X has determined that 1 point presents a 1 penny liability (e.g. $1000).

E is offering a 2 penny promotional Z per point at its Las Vegas Casino that can be used for 75% of a room payment or in promotional gaming dollars.

C is visiting Las Vegas and decides to take E's offer and stay with E.

Y offers to take C's points from X at a cost to X of 0.5 penny per point. X buys and hence X has reduced its liability for C's points by 100% in that transaction at a cost of 50% of what it would have cost if C had opted to use the points in a transaction with X.

Y then offers to pay E, 0.2 penny per point and E1 takes the offer.

Y makes 100,000*(0.5−0.2)=$300 on that transaction.

Y then provides C with $2000 in promotional Z's for E1 and C uses those Z's to purchase 75% of five nights of accommodation and balance as promotional gaming dollars.

E has earned $200 from the transaction+25% of five night's accommodation (say $1000) and secured C as a customer on property with $1000 in promotional play to put through the machines.

C also has perceived real money value in excess of the value of C's points equivalent had they used those points with X.

Another embodiment may involve cash or points. In this example, Y acts as a broker for C and negotiates with the various E's to obtain an attractive deal for C. For example, C notifies Y of an intention to visit Las Vegas. C may post a basic profile with Y along with a commitment to spend either points or real money, and Y then gets the various E's to bid for C's points or cash in terms of promotional play or other benefits. In this example C puts up US$1000. Y takes 10% commission and offers US$900 for bids to the E's participating. The highest bid is $1500 in promotional play at Casino E1. C takes the offer and as a result may also decide to stay with that particular casino. Y may well be a travel site or travel broker or agent or Y may have a deal with such an entity or entities.

Y may also offer a lottery in partnership with Es and or Xs or on its own, where C may purchase tickets for Zs. At a determined frequency (e.g. once a week) the total of Z wagered in that period is pooled. A fractional sum (e.g. 50%) goes towards the prize and a second fraction or fee is retained by Y for provision of service (perhaps 20%) goes towards the operator, Y.

Y and the player cash out by either converting Z to actual cash, stock (and then cashing the stock), further entitlements, or merchandise. Hence, in this embodiment, Y may act as a broker for C, converting C's points into stock with the company that C holds points and the C may convert the stock to cash by selling the stock.

FIG. 6 illustrates is a flow chart depicting a lottery involving loyalty points.

A game is offered (1). Customers of the game provider will acquire tickets (e.g. Lottery, Keno or Bingo, roulette), or entry (e.g. some form of contest or raffle), or bet (e.g. a “point-buster” slot machine) using points or pseudo-currency or Z's (2). The participant company or companies wipe their point liability as additional tickets are acquired or fees paid (3). In the case where points are not being used in an instant game such as “slot play”, the funds are pooled until the game is closed (4).

The game is played (5), the winner or winners are paid (6), and the game operator takes the balance of the pool as its commission (7).

In one embodiment a company offers a number of points in exchange for a lottery, keno, bingo or similar ticket or voucher. The game of chance may be operated by the company or a third party. The objective is that the company greatly reduces its liability by having its customers gamble the points.

In another embodiment, the same principle as described above applies, except that more than one company is involved in the game of chance, requiring different rates of point conversion to tickets or vouchers to be applied.

In another embodiment, the company (or a third party) may convert loyalty points to purchase tickets in a state run lottery(s) or licensed game(s) on behalf of the player.

By way of a simple example:

Y presents an offer to all of X's customers to convert their points to Zs where 100 Zs buys a lottery ticket with a prize that increases subject to participation, with a minimum advertised guaranteed amount.

A total number of C's participate representing 100,000,000.00 point liability where one point=1 penny. Total=$1,000,000.00

X pays Y 0.4 c per point=$400,000.00

Y then pools the bets and determines to pay a first prize of $200,000.00 and many smaller prizes with a total value of $50,000.00

C wins the prize and so Y pays.

Y has made $150,000.00 in the transaction.

X has effectively saved $600,000.00 in the transaction through a reduction in liability.

### By Way of Another Example

Y offers a global lottery pool with a seed of US$500 million and potential to jackpot to $10 billion at 1000Z's per ticket.

Millions of customers request tickets, representing an ultimate conversion of US$50 billion worth of point liability from 1000 s of companies.

The companies ultimately pay Y US$15 billion. Hence the conversion of US$50 billion in points represents a net saving of US$35 billion and a write off of US$15 billion.

Y retains $5 billion for facilitating the exchange and lottery.

One or more customers share in US$10 billion prize pool.

Unclaimed prizes are either added to the next draw or returned to Y.

Having thus described several aspects of at least one embodiment of this invention, it is to be appreciated that various alterations, modifications and improvements will readily occur to those skilled in the art. Such alterations, modifications, and improvements are intended to be part of this disclosure, and are intended to be within the spirit and scope of the invention. Accordingly, the foregoing description is by way of example only.

What is claimed is:

1. A method for an agency to administer a brokering of loyalty points, for financial gain, comprising the steps of:
(a) obtaining a variety of loyalty points from a user;
(b) performing a conversion of points to a pseudo currency that is accepted by an organisation that trades in goods or services or gaming or lottery or gambling;
(c) returning the pseudo currency to the user from which loyalty points were obtained; and
(d) obtaining a fee for the conversion.

2. The method of claim 1, wherein:
the agency provides banking and related services in the pseudo currency.

3. The method of claim 1, wherein,
the pseudo currency applies to a region.

4. The method of claim 3, wherein,
the region is a state or province or country.

5. The method of claim 1, wherein,
the pseudo currency is a game-based-currency.

6. The method of claim 1, wherein,
the agency converts more than one type of royalty points into the pseudo currency.

7. The method of claim 1, wherein,
the pseudo currency is a gaming voucher.

8. The method of claim 1, wherein,
the pseudo currency is accepted by a different organisation.
